(19) United States
(12) Patent Application Publication
(10) Pub. No.: US 2002/0003108 A1
(43) Pub. Date: Jan. 10, 2002

(54) Process and installation for the treatment of effluents loaded with organic matter

(75) Inventor: Jean Bonnet, Angers (FR)

Correspondence Address: YOUNG & THOMPSON, 745 SOUTH 23RD STREET 2ND FLOOR, ARLINGTON, VA, 22202

(73) Assignee: Vaslin Bucher (Societe Anonyme)

(21) Appl. No.: 09/899,926

(22) Filed: Jul. 9, 2001

(30) Foreign Application Priority Data
Jul. 7, 2000 (FR) 0008929

(51) Int. Cl. C02F 3/02

(52) U.S. Cl. 210/614; 210/620; 210/639; 210/86; 210/96.1; 210/196; 210/257.2

(57) ABSTRACT

A process for automatic or semi-automatic treatment of effluents or waste water, in particular effluents loaded with organic or biological materials such as effluents from wine-production, consisting, in normal operation, of collecting the effluents to be treated during their production and transferring them into a suitable storage container, pretreating the stored effluents by aeration, and if need be, stirring, clarifying the pretreated effluent and carrying out a finishing treatment of this effluent before discharging into the natural environment or reusing.

### DESCRIPTION

The present invention relates to the field of environmental protection and treatment of waste, more particularly waste in the form of effluents which are more or less liquid and loaded with organic matter, and its object is a process and an installation for treating effluents or waste water, more particularly wine-production effluents produced by a cellar, a co-operative or a wine store.

Known from among the different solutions proposed and currently carried out for implementing the aforementioned pollution control treatments are, in particular, the processes and devices for treating domestic, agricultural or industrial effluents by aerated storage.

In these processes, the carbon-containing pollution is decomposed into carbon dioxide and sludges which are more or less mineralised by the action of a suitable biomass.

The French Patent No. 97 07547 (FR-A-2 764 595), of which the Applicant is Co-proprietor, describes, in particular, a process which is mainly adapted to the pollution control of effluents produced by wine-production cellars.

The production of these effluents is cyclical: wine harvest, decanting, filterings, cleaning operations, etc.

The frequency of the cycles is annual. The volume of storage required for the effluents usually corresponds to the annual volume of wine produced by the cellar concerned.

The known processes for pollution control by aerated storage generally implement four successive phases:

1. Pretreatment by aeration of the store (biological pollution control)

2. Clarification of the pre-treated effluent by decanting (separation of the liquid/sludge)

3. Finishing treatment of the clarified effluents (sand filters, infiltration channels, etc.)

4. Sludge treatment (mineralisation, thickening, etc.)

In the sequence of phases, the most critical stage relates to the passage from phase 1 to phase 2. At the beginning of phase 1, the pretreated effluent is difficult to decant. The user therefore has to verify that the decantability of the effluent is good before passing to phase 2. This verification is restricting. It is difficult to automate. This often leads the user to uselessly prolong phase 1 and to take considerable safety precautions with regard to the storage volume (oversizing).

Moreover, the person skilled in the art knows the techniques for clarifying effluents with poor decantability, some of which are very effective, for example microfiltration. Nevertheless, their implementation by automated processes involves numerous difficulties.

Microfiltration therefore involves great risks of blocking/clogging the filtration members used by the retained organic matter and necessitates cycles of washing/regeneration of said members which are very restricting for the user: frequency, technicality, efficiency monitoring, etc. On the other hand, this technique demands a relatively constant filtration/clarification throughput which appears in contradiction to the periodic peaks in effluent production, in particular in wine-production applications.

The problem posed to the present invention consists in improving the process and installation described in the document FR-A-2 764 595, so as to be able to:

automatically clarify the pretreated effluents, without restriction for the user, with a constant degree of pollution control in a large range of effluent production capacities;

reducing in a significant manner the storage volume while keeping a safety volume which is sufficient to absorb the effluent production peaks;

possibly designing treatment stations or installations which are totally autonomous and only need simple monitoring by the user;

obtaining a large reduction in the pollution from the crude effluents, in particular above 95%, measured, for example by the chemical oxygen demand, before returning to the natural environment in accordance with the strictest antipollution standards.

To this end, the object of the present invention is a process for automatic or semi-automatic treatment of effluents or waste water, in particular effluents loaded with organic or biological materials such as effluents from wine-production, substantially consisting, in normal operation, of collecting the effluents to be treated during their production and transferring them into a suitable storage container, pretreating said stored effluents by aeration, and if need be, stirring, clarifying the pretreated effluent and carrying out a finishing treatment of this effluent before discharging in the natural environment or reusing, characterized in that it consists of carrying out, with suitable means, an intermediate filtration of the effluents removed from the storage container to clarify them, prior to their finishing treatment as a function of the filling level N of said storage container, for example in the form of a tank or cistern, and, if need be, of the degree of residual pollution of the effluents removed therefrom.

The invention will be explained, by virtue of the description hereinafter relating to a preferred embodiment, given as a non-limiting example and explained with reference to the attached schematic drawings, in which:

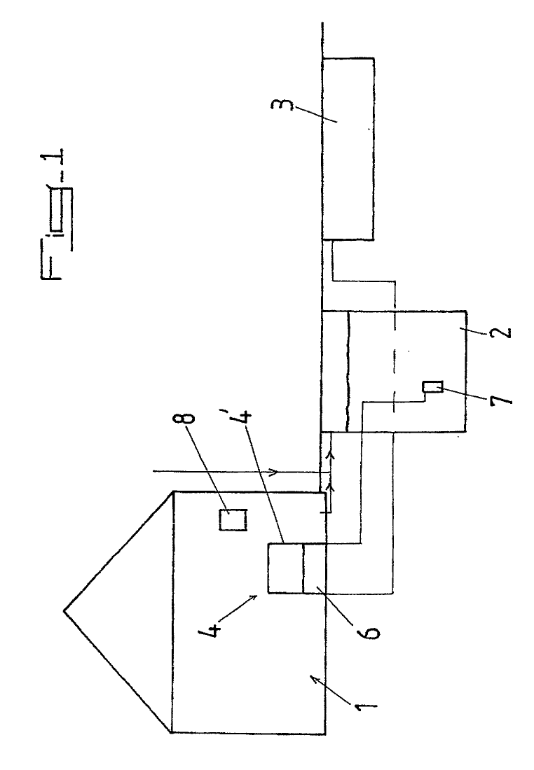

FIG. 1 is a schematic side view of an installation or station for implementing the process according to the invention;

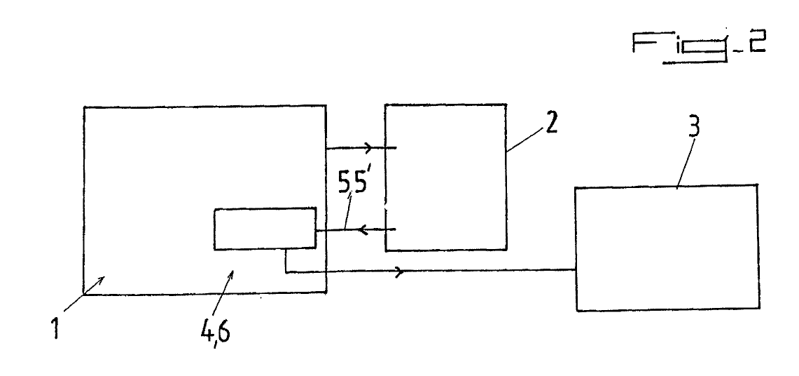

FIG. 2 is a schematic plan view of the installation or station in FIG. 1;

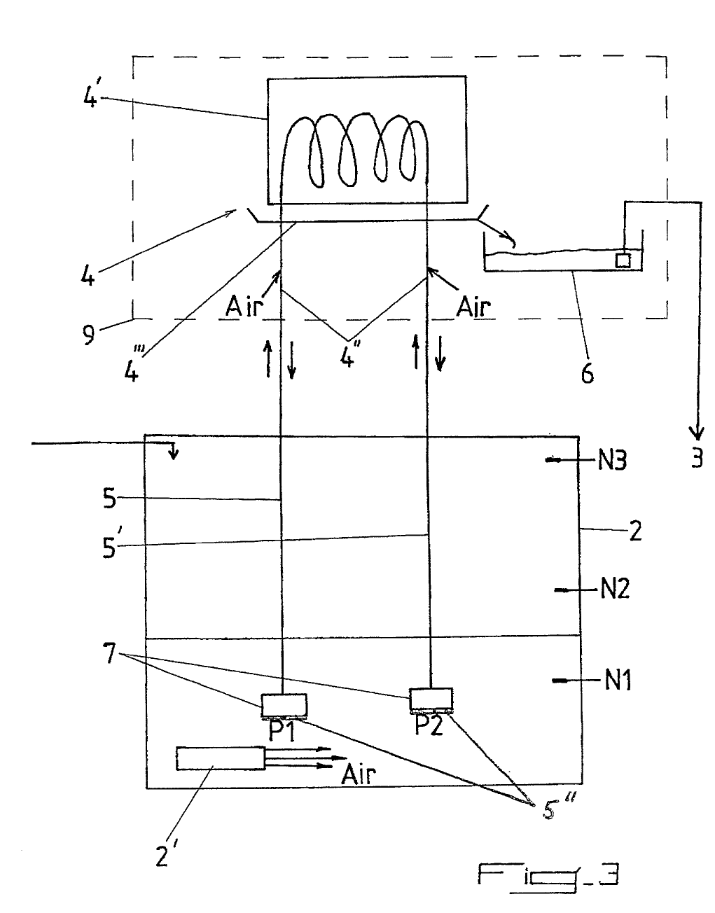

FIG. 3 is a detailed schematic view of the tank or cistern, the filtration means and the intermediate cistern being part of the installation shown in FIG. 1 and 2, according to an embodiment of the invention and,

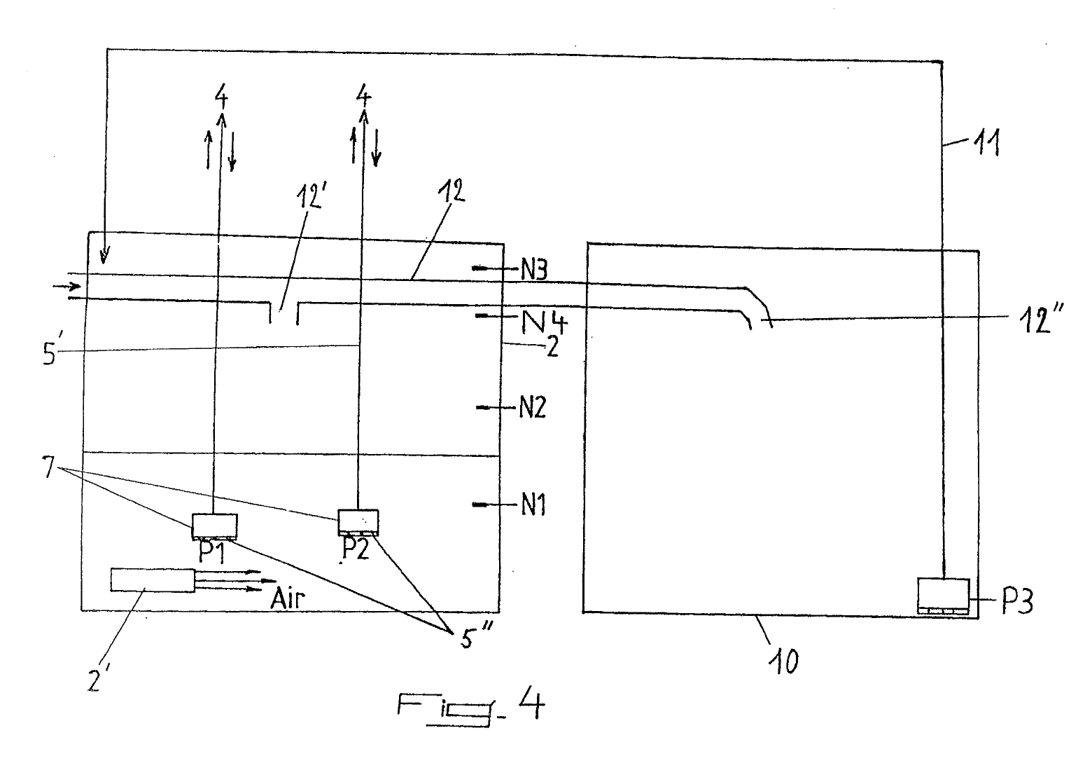

FIG. 4 is a partial view of another embodiment of the invention incorporating a relief tank.

The invention primarily relates to a process for automatic or semi-automatic treatment of effluents or waste water, in particular effluents loaded with organic or biological materials such as effluents from wine-production, substantially consisting, in normal operation, of collecting the effluents to be treated during their production and transferring them into a suitable storage container 2, pretreating said stored effluents by aeration, and if need be, stirring, clarifying the pretreated effluent and carrying out a finishing treatment of this effluent before discharging into the natural environment or reusing.

In conformity with the invention, this process also consists of carrying out, with suitable means 4, an intermediate filtration of the effluents removed from the storage container 2, prior to their finishing treatment as a function of the filling level N of said storage container 2, for example in the form of a tank or cistern, and, if need be, of the degree of residual pollution of the effluents removed from the latter, preferably estimated by the rate of consumption of the oxygen in said effluent. The oxygen content dissolves effluents being continuously measured with the aid, for example, of an oxymeter, an industrial sensor well known by the person skilled in the art.

This therefore involves an intermediate filtration which is only implemented in certain conditions determined by the volumes of effluents to be treated, their maximum possible time of residence in the container 2 and the degree of organic contamination of the effluents stored or removed from said container 2.

The container 2 is advantageously used as a temporary reservoir and the intermediate filtration is compulsorily carried out when the filling level N of the storage tank 2 exceeds a higher threshold value N2 and is authorized when the filling level N of the storage tank 2 is between a lower threshold value N1 and said higher threshold value N2 and in that the residual pollution degree is simultaneously less than a predetermined maximum threshold value, in particular as a function of the pollution control capacities of the finishing treatment means 3.

According to a preferred embodiment of the invention the conditional intermediate filtration consists of a tangential filtration, preferably by means of filtration 4 in the form of microporous tubular membranes grouped together in a filtering module 4′ and is carried out in diphasic flow by air injection, preferably in a cyclic manner, at the inlet or one of the inlets 4″ of said filtering module 4′. However, other modes of filtration suitable for effluents may also find application in the scope of the invention.

According to a characteristic of the invention, most particularly shown in FIG. 3, the intermediate filtration means 4 grouped together in a corresponding module 4′, are connected to the storage tank 2 by two paths 5, 5′ for circulating and routing the effluents, operating in an alternating manner and bringing said effluents to two ends 4″ of said module 4′, resulting, when needed, in two flows in opposing directions on at least one part of the circulation route in the module 4′and being capable of ending in an at least partial feedback of the effluents removed via a first path 5 or 5′ towards the storage tank 2 through the second routing path 5′ or 5.

It is thus possible to ensure almost permanent filtration (and therefore almost permanent removal) which is not dependent on a possible clogging of a routing path, the alternate use of each of the paths involving a freeing of the path and the suction aperture not being used (by the partial backflow) and cleaning action of the filtering elements (by the reverse flow), allowing the rinsing phases to be spaced.

The effluents are removed from the storage tank 2 at a level substantially corresponding to the lower filling threshold value N1 and the filtered effluents are received in an intermediate storage container 6, prior to their controlled discharge on one or a plurality of filtering masses 3, buried or otherwise, forming the finishing treatment means.

The object of the present invention is also, as shown in FIGS. 1 to 3 of the attached drawings, an installation or station for the automatic treatment of effluents or waste water for the implementation of the above-described process, substantially consisting of a storage container or tank 2 receiving effluents during their production and comprising means for the controlled aeration 2′ and/or stirring of its contents (not shown), finishing treatment means 3 for the pretreated and clarified effluents removed from said storage tank 2, means 5, 5′, 7 for removing and routing pretreated effluents and sensor means associated with a unit 8 for the control and management of the installation operation.

According to the invention, this installation also comprises active filtering means 4 functionally located between the storage tank 2 and the finishing treatment means 3, supplied by effluents removed from the storage tank 2 and discharged after filtering on finishing treatment means 3, said active filtering being compulsorily carried out, on the one hand, when the filling level N of the storage tank 2 exceeds a higher threshold value N2 and, on the other hand, authorized when the filling level N of the storage tank 2 is between a lower threshold value N1 and said higher threshold value N2 and that the degree of residual pollution is simultaneously less than a predetermined maximum threshold value, in particular as a function of the pollution control capacities of the finishing treatment means 3, said rate bring preferably estimated by the rate of consumption of the oxygen in the stored effluents.

The effluents produced by the site 1, for example a cellar, are then transferred towards a storage tank 2, which is optionally buried and the internal volume of which can be relatively small.

In an application for treating wine-production effluents, the volume of said storage tank 2, which is preferably at least partially buried, advantageously corresponds to approximately 10 to 20%, preferably 15% of the volume of the effluent produced in one year by said site 1, the lower filling threshold value N1 corresponding to approximately 25 to 40%, preferably approximately 33% of the volume of said storage tank 2 and the upper filling threshold value N2 corresponding to approximately 40% to 60%, preferably approximately 50%, of the volume of said storage tank 2.

The tank 2 is provided with means for aeration and conventional stirring, for example of the submergible aerator type or membrane diffusers, and for measuring the rate of oxygen dissolved in the stored effluent, for example by using an oxymeter associated with a transmitter.

A conventional warning button, possibly managed by the unit 8, between the aeration means and measurement of the dissolved oxygen will allow the rate of dissolved oxygen to be maintained between two values, for example between 0.5 and 2 mg of oxygen per liter of effluent. This permanent oxygenation of the effluents gives the station high reactivity and is very favorable to a rapid mineralisation of the sludges.

In view of the nature of the effluents to be treated, the active filtration means 4 attached to the tank 2 comprise a tangential filtering module 4′ containing microporous tubular membranes, filtering being carried out by diphasic flow and the removal of effluents in the storage tank 2 being carried out at a level substantially corresponding to a lower filling threshold value N1 or at a slightly lower level.

The above-mentioned type of filtration is known to the person skilled in the art and, in an embodiment example applicable to the invention, the porosity of the membranes is between 0.05 and 0.2 micrometers, the diameter of the filtering tubes is between 4 and 10 mm and the speed of circulation in the tubes is between 1 and 3 m/s.

To prevent very rapid blocking of the whole of the filtration it is advantageous to provide permanent cleaning of the filtering elements and the suction zones for the effluents in the tank 2. The cleaning of the filtering elements uses the known technique of diphasic flow by cyclically or continuously injecting air at the inlet of the membranes in such a way as to obtain a ratio of the volumes of liquid/air between 1 and 2 in the tubular membranes.

To ensure a circulation of the effluents in the filtration means 4 and to clean the suction zones in the storage tank 2 where necessary, the installation comprises two distinct circulation paths or lines 5 and 5′ for removing the effluents and the routing thereof towards the intermediate filtering means 4, each comprising its own suction aperture 5″, connected to opposing ends of said active filtering means 4 and each comprising a transfer member 7 of the pump type or a common transfer member capable of being alternately incorporated in one or the other of the two parallel circulation lines or paths 5 and 5′.

Two identical pumps 7 immersed in the tank 2 can thus be used, each pump being attached to one of the ends of the filtering elements of the means 4 (FIG. 3). When one pump operates it cleans the suction filter of the other pump. Therefore it is sufficient to cyclically reverse the control of the pumps to obtain regular cleaning of the suction zones.

The pairing pump 7/filtering elements 4 is determined so as to obtain the required rate of circulation and pressure in the filtering elements.

The mean filtration throughput should substantially correspond to the mean throughput of effluent production during the periods of intense activity.

The installation also comprises, in an advantageous manner, an intermediate storage container 6 for collecting the effluents filtered at the outlet of the filtering means 4 and associated with means for controlled transfer of said filtered effluents towards said finishing treatment means 3, for example in the form of one or more sand masses or similar (infiltration channel or filtering knoll).

As shown in FIG. 3 of the attached drawings, the filtration means 4 may, for example, consist of a tubular membrane, several meters in length and of the aforementioned type, which is coiled and into which the removed effluents are injected under pressure by one of its two end apertures (corresponding to the opposing inlet 4″ of the module 4′), the non-filtered effluent returning into the storage tank 2.

The filtered effluent, once it has crossed the membrane wall, accumulates in drops on the external face of said wall (on the injection side) and drops under the influence of gravity into a collecting tray 4′″ extending beneath said coil.

The filtered and collected effluent runs into the intermediate storage cistern 6 whence it is transported towards the finishing treatment means 3, for example by an immersed suction pump associated with a measuring member.

The different elements 4, 4′, 4′″ and 6 mentioned above can, for example, be fitted together in a box or a support frame 9.

As the volume of the intermediate container 6 or cistern is known, the emptying frequencies of the cistern enables the filtration throughput to be calculated. When the filtration throughput has dropped in a significant manner, for example more than 50%, the unit 8, for example an automaton, which monitors the installation can control automatic rinsing, in hot water, of the filtering elements of the means 4.

When rinsing does not allow the initial performances of the filtering elements to be restored, chemical washing is carried out. Owing to the effectiveness of the cleaning and rinsing processes, the frequency of the washing processes is low, about 8 washing processes per year. The washing cycles can also be totally automated.

The storage tank 2 is further provided with means for controlled aeration 2′ and stirring (not shown) and different level detectors for determining the filling level thereof.

N1 corresponds to the minimum level of effluents in the tank 2. In the corresponding volume, the biomass is progressively concentrated and mineralised. This volume allows the entering crude effluent to be diluted and provides the station or installation with high reactivity.

The lower filling threshold value N1 of the storage tank 2 preferably corresponds in volume to approximately 5 days of production of effluents in a period of intense activity of the production site 1 concerned, the volume corresponding to the upper filling threshold value N2 being higher by about 50% than the said volume corresponding to the lower filling threshold value N1.

In normal stabilized functioning, the level of effluents in the tank 2 is between N1 and N2. The suction zone of the pumps 7 is slightly below N1. As this shows, N1 corresponds approximately to a third of the volume of the tank 2, and N2 corresponds to about a half.

According to the invention, a filling safety level N3 for the storage tank 2 is defined, at which an alarm is triggered, said safety level N3 corresponding to approximately 90% of the maximum capacity of said storage tank 2.

The volume between N2 and N3 corresponds to the safety volume for absorbing the production peaks of the effluents. The volume corresponding to N3 must be adapted to the risks of accidental over-productions. The positions of the levels N1 and N2 are not critical, they may drop by 10 to 20% to encourage the safety volume for absorbing the production peaks of effluent, or increase by 10 to 20% for encouraging storage of the sludges.

Filtration is possible between N1 and N2, above N2 it is compulsory.

Between N1 and N2 filtration will be authorized as a function of the level of residual pollution of the effluents, estimated, for example, by the technique known under the name of respirometry.

This technique allows the degree of pollution of the effluents to be estimated by measuring the activity of the purifying biomass by the rate of consumption of the oxygen dissolved in the effluent. For this, it is sufficient to measure the time necessary for the rate of oxygen dissolved in the effluent to pass, in the absence of aeration, from the maximum value, for example 2 mg of oxygen per liter, to the minimum value, for example 0.5 mg of oxygen per liter. It is very easy to measure this time as it corresponds to the length of the stoppage time of the automatic aeration system of the tank 2. For a residual pollution of about 1 g/l expressed in COD, the time necessary for passing from the maximum value above, 2 mg/l, to the minimum value, 0.5 mg/l, is about 16 mn for a temperature of 12° C. It is necessary to make a correction as a function of the temperature of the effluent:

d=20-0.3 t

d=stoppage time corresponding to a COD equal to 1 g O2/l

t=temperature ° C.

If the stoppage time is higher than or equal to d (t), filtration is possible.

If the level of effluents in the tank exceeds N2, filtration is compulsorily commanded. This situation corresponds to an abnormal over-production of effluents. The installation should be capable of storing and absorbing the peak, even if the residual pollution of the effluents is above 1 g/l. The finishing treatment means, for example of the sand filter type, easily absorb an accidental overload.

If the level N3 is reached, an alarm signals the abnormal functioning of the station. The position of N3 in the tank 2 should still authorize, at least, the storing of a normal day of effluent production.

When the level N1 is reached at the end of filtration, filtration is stopped and the membranes are rinsed.

The installation is monitored, for example, by an industrial programmable automaton. All the functions: aeration, filtration, rinsing/washing of the filter, mineralisation of the sludges, level control, safety precautions, etc. are automated.

Owing to the above-mentioned process and installation, it is possible to carry out an effective treatment of rejected effluents with very variable throughputs by means of an installation comprising a single reactor (storage tank 2 with means of pre-treatment by aeration and stirring) with a relatively small volume, associated with a means of dynamic filtration, said filtration being carried out in a controlled manner as a function of the quality and the quantity of the effluents in the above-mentioned reactor.

This pollution control treatment which is carried out without recycling of the sludges, without decanting and without producing a fixed biomass, is completed by a final phase of discharging the filtered effluents with a compatible COD content on one or more silicic masses (sand masses);

The phase of dynamic filtration consists in fine filtration (ultra-filtration) on membranes (0.1 μm) with automatic cleaning sequences and with a tangential effect resulting from the rate of circulation of the effluents relative to said membranes.

In the cases where the flow of effluents to be treated is likely to occasionally have peaks generating volumes which are higher than the current absorption capacity, or even higher than the total volume of the storage tank 2, it may be advantageously provided, as shown in FIG. 4 of the attached drawings, that the installation also comprises an additional relief tank 10 recovering the flow of effluents to be treated instead of the storage tank 2 when the filling of this storage tank 2 reaches or exceeds a predetermined threshold level, said relief tank 10 being provided with a line 11 for transferring the effluents towards the storage tank 2, incorporating a recirculating pump P3 which is activated when the filling level of said storage tank 2 reaches or falls below a filling threshold value N4.

This relief tank 10 is not normally provided with means for pretreating effluents.

In conformity with an additional characteristic of the invention, the installation advantageously comprises a single discharge pipe 12 for supplying the storage tanks 2 and relief tanks 10 with effluents from above, the latter being arranged in the order storage tank 2/relief tank 10 in the flow direction of the flow in said pipe 12 and this latter being provided with a first discharge aperture 12′ emerging in the storage tank 2 and a second discharge aperture 12″ emerging in the relief tank 10.

Said discharge pipe 12 will be arranged substantially horizontally, will traverse the storage tank 2 in its upper part and will comprise a first discharge connector corresponding to the first aperture 12′ and directed towards the base of said tank 2.

Thus, when the filling level of the storage tank 2 reaches the pipe 12, the effluent surplus produced will flow beyond said first aperture 12′ and will be automatically discharged into the relief tank 10.

The invention is obviously not limited to the embodiment described and shown in the attached drawings. Modifications are possible, in particular from the point of view of the structure of the various elements or by substitution of equivalent techniques, without departing thereby from the scope of protection of the invention.

1. Process for automatic or semi-automatic treatment of effluents or waste water, in particular effluents loaded with organic or biological materials such as effluents from wine-production, substantially consisting, in normal operation, of collecting the effluents to be treated during their production and transferring them into a suitable storage container, pretreating said stored effluents by aeration, and if need be, stirring, clarifying the pretreated effluent and carrying out a finishing treatment of this effluent before discharging into the natural environment or reusing, characterized in that it consists of carrying out, with suitable means (4), an intermediate filtration of the effluents removed from the storage container (2), prior to their finishing treatment as a function of the filling level (N) of said storage container (2), for example in the form of a tank or cistern, and, if need be, of the degree of residual pollution of the effluents removed in the latter, preferably estimated by the rate of consumption of the oxygen in said effluent.

2. Process according to claim 1, characterized in that the intermediate filtration is compulsorily carried out when the filling level (N) of the storage tank (2) exceeds a higher threshold value (N2) and is authorized when the filling level (N) of the storage tank (2) is between a lower threshold value (N1) and said higher threshold value (N2) and in that the degree of residual pollution is simultaneously less than a predetermined maximum threshold value, in particular as a function of the pollution control capacities of the finishing treatment means (3).

3. Process according to any one of claims 1 and 2, characterized in that the conditional intermediate filtration consists of tangential filtration, preferably by means of filtration (4) in the form of microporous tubular membranes grouped together in a filtering module (4′) and is carried out in diphasic flow by air injection, preferably in a periodic manner, at the inlet or one of the inlets (4″) of said filtering module (4′).

4. Process according to any one of claims 1 to 3, characterized in that the intermediate filtration means (4) grouped together in a corresponding module (4′), are connected to the storage tank (2) by two paths (5, 5′) for circulating and routing the effluents, operating in an alternating manner and bringing said effluents to two ends (4″) of said module (4′), resulting, when needed, in two flows in opposing directions on at least one part of the circulation route in the module (4′) and being capable of ending in an at least partial feedback of the effluents removed via a first path (5 or 5′) towards the storage tank (2) through the second routing path (5′ or 5).

5. Process according to any one of claims 2 to 4, characterized in that the effluents are removed from the storage tank (2) at a level substantially corresponding to the lower filling threshold value (N1) and in that the filtered effluents are received in an intermediate storage container (6), prior to their controlled discharge on one or more filtering masses (3), buried or otherwise, forming the finishing treatment means.

6. Installation or station for the automatic treatment of effluents or waste water, for carrying out the process according to any one of claims 1 to 5, substantially consisting of a storage container or tank receiving effluents during their production and comprising means for the controlled aeration and/or stirring of its contents, finishing treatment means for the pretreated and clarified effluents removed from said storage tank, means for removing and routing pretreated effluents and sensor means associated with a unit for the control and management of the installation operation, characterized in that it also comprises active filtering means (4) functionally located between the storage tank (2) and the finishing treatment means (3), supplied by effluents removed from the storage tank (2) and discharged after filtering on finishing treatment means (3), said active filtering being compulsorily carried out, on the one hand, when the filling level (N) of the storage tank (2) passes a higher threshold value (N2) and, on the other hand, authorized when the filling level (N) of the storage tank (2) is between a lower threshold value (N1) and said higher threshold value (N2) and that the degree of residual pollution is simultaneously less than a predetermined maximum threshold value, in particular as a function of the pollution control capacities of the finishing treatment means (3), said rate preferably being estimated by the rate of consumption of the oxygen in the stored effluents.

7. Installation according to claim 6, characterized in that, as the active filtering means (4) comprise a tangential filtering module (4′) containing microporous tubular membranes, filtering is carried out by diphasic flow and the removal of effluents in the storage tank (2) is carried out at a level substantially corresponding to a lower filling threshold value (N1) or at a slightly lower level.

8. Installation according to any one of claims 6 and 7, characterized in that it comprises two distinct circulation paths or lines (5 and 5′) for removing the effluents and the routing thereof towards the intermediate filtering means (4), each comprising its own suction aperture (5″), connected to opposing ends of said active filtering means (4) and each comprising a transfer member (7) of the pump type or a common transfer member capable of being alternately integrated in one or the other of the two parallel circulation lines or paths (5 and 5′).

9. Installation according to any one of claims 6 to 8, characterized in that, in the case of treatment of the wine effluents from a wine-production site (1), the volume of the storage tank (2), which is preferably at least partially buried, corresponds to approximately 10 to 20%, preferably 15% of the volume of the effluent produced in one year by said site (1), the lower filling threshold value (N1) corresponding to approximately 25 to 40%, preferably approximately 33% of the volume of said storage tank (2) and the upper filling threshold value (N2) corresponding to approximately 40% to 60%, preferably approximately 50%, of the volume of said storage tank (2).

10. Installation according to any one of claims 6 to 9, characterized in that said lower filling threshold value (N1) of the storage tank (2) corresponds in volume to approximately 5 days of production of effluents in a period of intense activity of the production site (1) concerned, the volume corresponding to the upper filling threshold value (N2) being higher by about 50% than the said volume corresponding to the lower filling threshold value (N1).

11. Installation according to any one of claims 6 to 10, characterized in that it also comprises an intermediate storage container (6) for collecting the effluents filtered at the outlet of the filtering means (4) and associated with means for controlled transfer of said filtered effluents towards said finishing treatment means (3), for example in the form of one or more sandblocks or similar.

12. Installation according to any one of claims 6 to 11, characterized in that a filling safety level (N3) for the storage tank (2) is defined, at which an alarm is triggered, said safety level (N3) corresponding to approximately 90% of the maximum capacity of said storage tank (2).

13. Installation according to any of claims 6 to 11, characterized in that it further comprises an additional relief tank (10) recovering the flow of effluents to be treated instead of the storage tank (2) when the filling thereof reaches or exceeds a predetermined threshold, said relief tank (10) being provided with a line (11) for transferring effluents towards the storage tank (2), integrating a recirculating pump (P3) which is activated when the filling level of said storage tank (2) reaches or falls below a threshold filling value (N4).

14. Installation according to claim 13, characterized in that it comprises a single discharge pipe (12) for supplying the storage tanks (2) and relief tanks (10) with effluents from above, the latter being arranged in the order storage tank (2)/relief tank (10) in the flow direction of the flow in said pipe (12) and this latter being provided with a first discharge aperture (12′) emerging in the storage tank (2) and a second discharge aperture (12″) emerging in the relief tank (10).
